(19) United States
(12) Patent Application Publication
(10) Pub. No.: US 2020/0093099 A1
(43) Pub. Date: Mar. 26, 2020

(54) PET STEP

(71) Applicant: Judith S. Pollack, Knoxville, TN (US)

(72) Inventor: Judith S. Pollack, Knoxville, TN (US)

(21) Appl. No.: 16/140,925

(22) Filed: Sep. 25, 2018

(51) Int. Cl. A01K 29/00; A47C 12/00

(52) U.S. Cl. CPC A01K 29/00; A47C 12/00

(57) ABSTRACT

A pet step for helping domestic pets move between surfaces of different elevations, including a unitary component having a top surface and a bottom surface that are connected by a scalloped-like sidewall.

### BACKGROUND INFORMATION

### Field of the Invention

The invention relates to steps that are used to assist animals, in particular canines, in moving from one surface are to another.

### Discussion of Prior Art

Many domestic pets, particularly canines, frequently need to access surfaces and areas that are above floor-level or ground-level, such as when entering a car and/or getting onto a piece of furniture (if allowed). Some puppies may have the ability to jump onto these surfaces, however, as canines' age they often require assistance. Many large breeds often develop arthritic problems making such movements difficult or impossible. Also, some canines may require surgery at some point thus requiring assistance post-operation. Lastly, large breed puppies are often too heavy to lift but do not yet have the strength to reach the desired surface.

Conventional solutions to this problem include small stair cases and ramps. However, small stair cases still tend to be too large, heavy, and cumbersome to be practical in most circumstances and are not easily portable. Ramps are similarly cumbersome, often long and heavy. Larger breeds of dogs are not comfortable and often outright refuse using ramps because of their somewhat, unique dimensions. Larger breeds in particular are intimidated by both small portable staircases and ramps, rendering each quite useless.

What is needed, therefore, is a sturdy but lightweight pet step that is easily portable and not intimidating.

### BRIEF SUMMARY OF THE INVENTION

The invention is a pet step that assists pets. In particular: large breed puppies, large breed arthritic canines, large breed canines following surgery and large breed canines who have recently suffered an injury, in moving from one surface to another. The pet step is a unitary component having a top surface upon which pets may comfortably stand, land-on, get-on, step onto, and jump-from or jump onto, a bottom surface that is designed to hold its position on a ground surface and that has a sidewall connecting the top surface and the bottom surface forming a scalloped-like edge around the whole pet step itself.

The shape of the step and in particular the scalloped-like edge is nonthreatening to most pets, particularly large canines. The shape presents a wide area that most pets are comfortable getting onto and off-of, and provides an excellent area to weight ratio as the outer portions of the scalloped edges create an illusion of large surface area without the added weight that would come from having solid sidewalls.

The unitary component is made of a sturdy and durable but lightweight material so as to support the weight of large pets yet be light enough to be easily portable. It may be hollow, partially hollow, or solid, however, durable water-resistant foams are generally advantageous for achieving the objectives of the invention.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a top perspective view of the pet step according to the invention.

FIG. 2 is a bottom perspective view.

FIG. 3 is a top plan view.

FIG. 4 is a side plan view.

FIG. 5 is a top perspective view of a second embodiment of the pet step having handles embedded in the sidewalls of the pet step.

FIG. 6 is a bottom perspective view of the second embodiment.

FIG. 7 is a top plan view of the second embodiment.

FIG. 8 is a side view of the second embodiment.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

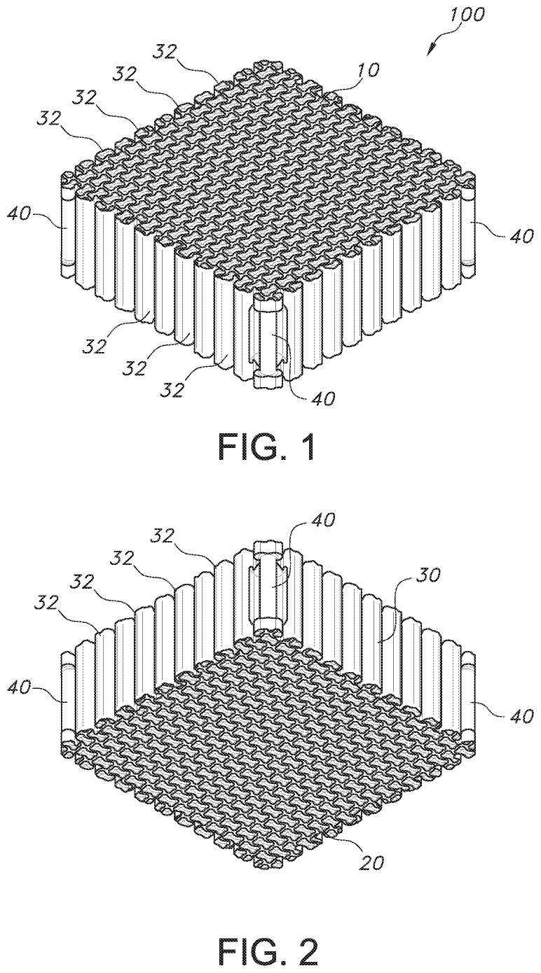

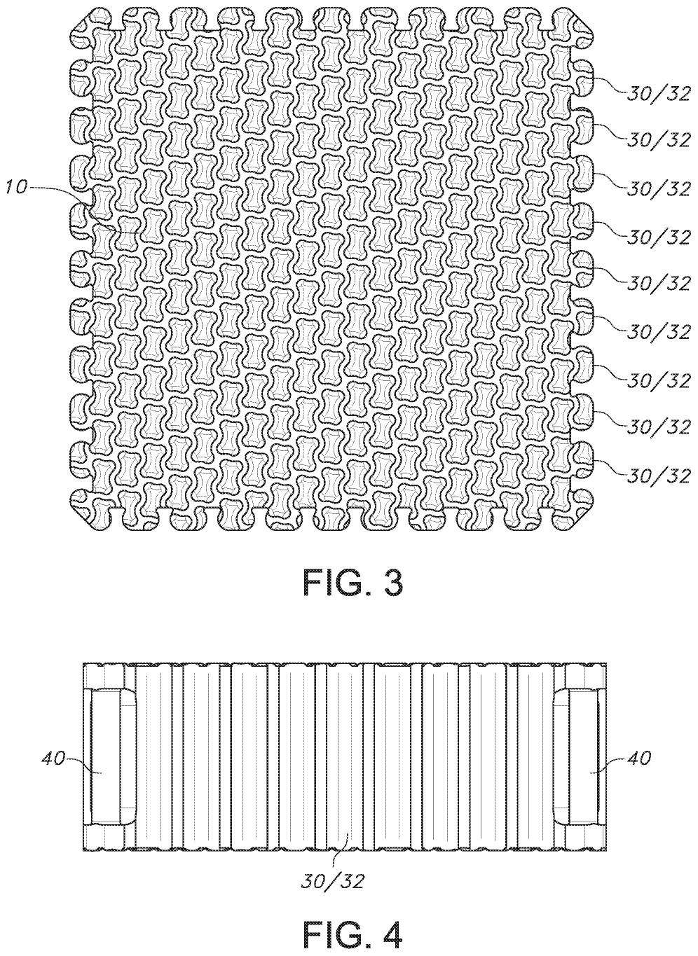

FIGS. 1-4 illustrate the first embodiment of the pet step 100 according to the invention, which is in the form of a unitary component having a top surface 10, a bottom surface 20, and at least one sidewall 30, the sidewall 30 forming a scalloped-like edge around the pet step 100.

The pet step 100 may be a solid component, a hollow component, or a partially hollow component, depending on the choice of material from which the step is made. For example, the pet step 100 may be a solid component that is comprised of durable water resistant foam or foam rubber, such as ethylene-vinyl acetate (EVA) foam rubber. Such a material creates a pet step 100 that is sturdy enough to allow a large canine to use the device 100 as a step yet is light enough for a person to easily move and transport. Using this material to make a solid foam block also creates a pet step that is shock absorbing when a pet steps onto the pet step 100. There are also a number of convention ridged plastics that are known in the art and that may be used to create a hollow component that has the desired strength and weight.

The top surface 10 is a gripping surface and may either be formed as a part of the unitary component or may be adhesively applied to the top of the solid foam block. For example, when the pet step is made from durable water-resistant foam, as shown in the drawings, the top surface 10 is the upper surface of the foam block, the foam material providing a measure of grip itself, with a design imprinted on the top surface so as to provide additional gripping. Alternatively, a separate gripping surface may be adhesively added to the top surface 10 using conventional means. Suitable gripping surfaces include various conventional rubber sheets and/or plastic materials having small ridges, the ridges potentially being placed in different directions, for example, vertical and horizontal lines or v-notches, so as to create better grip.

The bottom surface 20 is similarly designed so as to create a griping fit against a floor or ground surface. As with the top surface 10, the bottom surface 20 may have a certain degree of grip simply from the material from which the pet step 100 is made, i.e., certain foams naturally provide a degree of grip. The bottom surface 20 may also have ridges imprinted onto it, as shown in FIGS. 2 and 6 to provide additional grip. A conventional gripping surface, such as those described for the upper surface 10, may be added to the bottom surface 20 using conventional means to increase the grip.

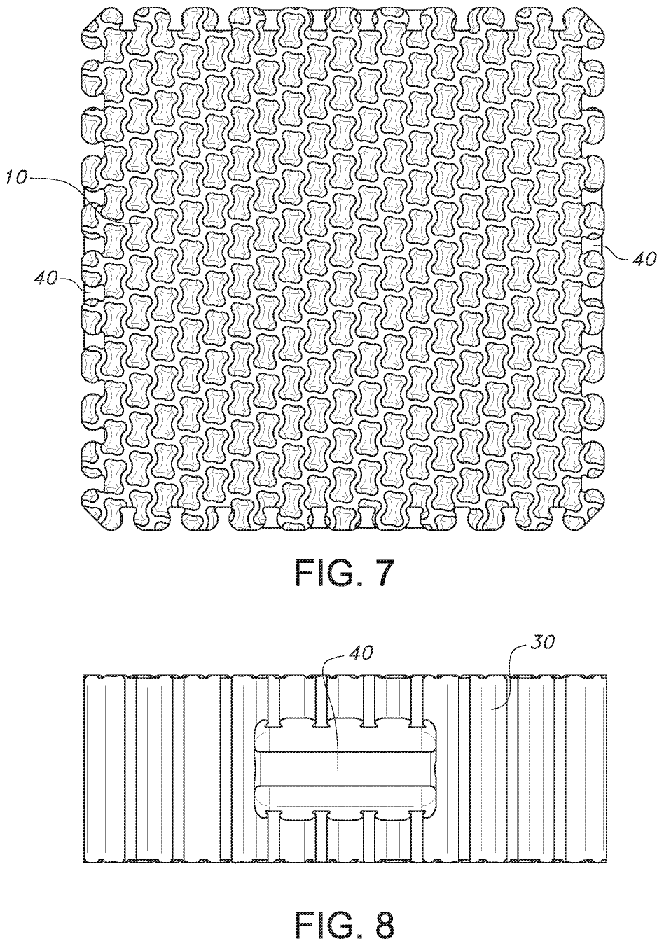

The sidewall 30 creates a scalloped-like edge around the pet step 100, meaning that the edge has a plurality of slightly curved protrusions 32. The sidewall 30 may be in various shapes. For example, the sidewall 30 shown in FIGS. 1-8 includes four sidewalls 30 that are approximately in the shape of a square. Alternatively, the sidewall 30 may, for example, include four sides and be in the shape of a rectangle, or, it may be a single sidewall that is in the shape of a circle or an oval.

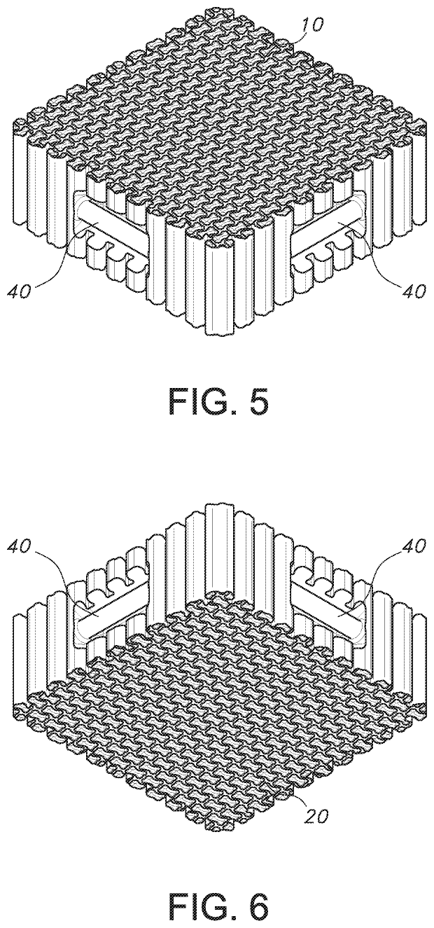

Handles 40 may also be provided. For example, in the first embodiment shown in FIGS. 1-4, each corner of the pet step 100 includes a vertically aligned handle, while the second embodiment shown in FIGS. 5-8 includes four handles 40 that are embedded in the sidewall. These handles may be a formed as a part of the unitary component. For example, when the unitary component is made of solid foam the handles may be cut or carved into the foam. Alternatively, the handles may be external components that are created using conventional means and that are subsequently affixed to the pet step 100, also using conventional means.

The pet step may take many shapes and sizes depending on the intended purpose. For example, a pet step that has a height of approximately 7 inches, and a width and length of approximately 23 inches, respectively, is particularly well suited for large dogs and is still easily transportable. This particular design is large enough to assist most large breed dogs yet still be small enough to fit behind the seats in most vehicles and slide beneath most beds. When the pet step 100 is made of a solid EVA foam and sized and shaped as described above, it creates an easily portable pet step that is sized to support large canines while weighing not more than 15 pounds, thus making it easily portable and useful in numerous situations.

It is understood that the embodiments described herein are merely illustrative of the present invention. Variations in the construction of the pet step may be contemplated by one skilled in the art, without limiting the intended scope of the invention herein disclosed and as defined by the following claims.

What is claimed is:

1. A pet step comprising:
A unitary component having a top surface and a bottom surface that are connected to one another by at least one sidewall, and wherein the sidewall forms a scalloped-like edge of the unitary component.

2. The pet step of claim 1, wherein the at least one sidewall includes four sidewalls and is approximately in the shape of a square.

3. The pet step of claim 2, wherein one or more of the four sidewalls include a handle.

4. The pet step of claim 3, wherein the top surface is a gripping surface.

5. The pet step of claim 4, wherein the top surface is shock absorbing.

6. The pet step of claim 5, wherein the bottom surface is a gripping surface.

7. The pet step of claim 6, wherein the unitary component is comprised of a water-resistant foam rubber.

8. The pet step of claim 7, wherein the water-resistant foam rubber is ethylene-vinyl acetate foam rubber.
